(19) United States
(12) Patent Application Publication
(10) Pub. No.: US 2009/0150204 A1
(43) Pub. Date: Jun. 11, 2009

(54) INTERACTIVE SALES PLANNER

(75) Inventors: Zachary James MIDED, San Franscisco, CA (US); Baruch Ismail SAEED, Berkeley, CA (US)

Correspondence Address: SUGHRUE MION, PLLC, 2100 Pennsylvania Avenue, N.W., Washington, DC, 20037, US

(73) Assignee: MAXAGER TECHNOLOGY, INC., San Rafael, CA (US)

(21) Appl. No.: 11/951,199

(22) Filed: Dec. 5, 2007

(51) Int. Cl. G06Q 10/00

(52) U.S. Cl. 705/8; 705/7

(57) ABSTRACT

The interactive sales planner allows users (e.g., salespersons) to make real time sales decisions in accordance with a profit-maximizing business (e.g., sales) plan. The interactive sales planner uses target information of an optimized business plan generated using business data of an organization. The method is highly efficient in organizations having many products, many customers, and complex production facilities with multiple, interactive product flows.

### TECHNICAL FIELD

The present invention generally relates to enterprise information systems, and more particularly, it relates to a method and system for sales plan execution.

### BACKGROUND OF THE INVENTION

The following documents are incorporated by reference herein, in their entirety, for their useful background information concerning various topics in the more specific discussion which follows: U.S. patent application publication no. 20050065838, dated March 2005, of Kalagnanm, et al.; U.S. patent application publication no. 20030101101, dated May 2003, of Ko-Cheng; U.S. patent application publication no. 20060155596, dated July 2006, of Adam; U.S. patent application publication no. 20070016494, dated January 2007, of Brown, et al.; and U.S. Pat. No. 6,847,936, dated January 2005, of Fang.

Providers (e.g., manufacturers) of consumer goods, products, items or services (collectively referred to as “products”) seek to maximize their profits and revenue growth. Ordinary ways to increase the revenue include increasing the number of products sold or increasing the profit margin for each product sold by increasing the selling price and/or by reducing the costs of materials, production, and distribution of products.

Manufacturers of products typically develop sales plans to help increase sales revenues, volumes, and/or prices related to their products. A sales plan is typically created starting with historical business data that specifies, for example, which products were sold to which customers at what quantities and prices. Such business data is generally collected from multiple data sources, including spreadsheets, online transaction processing (OLTP) applications, and specialized databases, called operational data stores (ODS). The OLTP applications are enterprise systems that manage a company's basic transactions, such as supply chain management (SCM), customer relationship management (CRM), sales and operations planning (S&OP), corporate performance management (CPM), and enterprise resource planning (ERP).

Manufacturers typically create sales forecasts at some level of aggregation by product and customer using the collected data. These forecasts include assumptions about sales growth, price inflation, new products, and new customers. The sales forecasts are then adjusted according to inputs from the production department to ensure the sales fit within available capacity to meet the overall objective of a sales plan. This adjustment process is typically performed using analytical tools, such as spreadsheets, applications such as those mentioned above, custom applications, and the like. This process takes place periodically, e.g., weekly, monthly, quarterly or annually.

Using sales plans, salespersons make detailed sales decisions to meet their overall targets, such as revenue and volume. Such decisions include, for example, at what price and volume to sell products and to which customers to offer products. However, as the sales plans are usually developed based on aggregated data, and salespersons typically lack detailed knowledge of how individual products for specific customers may utilize production assets and resources, they have an inaccurate view of how their sales decisions will affect overall profitability. Furthermore, these inefficiencies become even more apparent as salespersons inevitably negotiate different prices and quantities by product for their specific customers, as they do not know how these deviations from the sales plan affect overall profitability.

It would be therefore advantageous to provide a solution that allows users to make real-time sales decisions for example at the customer's premise without adversely affecting the profit of the organization.

### BRIEF DESCRIPTION OF THE DRAWINGS

FIG. 1 is a flowchart describing the process of generating an optimized target sales plan.

FIG. 2 is a block diagram of the interactive sales planner disclosed in accordance with an embodiment of the present invention.

FIG. 3 is a diagram of the interactive sales planner's display generated in accordance with an embodiment of the present invention.

FIG. 4 is a flowchart describing the method for interactively generating sales recommendations using the interactive sales planner implemented in the accordance with an embodiment of the present invention.

FIG. 5 is a matrix for displaying sales recommendations.

### DETAILED DESCRIPTION OF THE INVENTION

The following detailed description teaches the invention by way of non-limiting, exemplary embodiments. The embodiments are not meant to define the limits of the invention but, rather, to instruct those familiar with this field in a practical implementation. The true scope of the invention should be ascertained with reference to the appended claims.

The present invention provides an interactive sales planner that allows users (e.g., salespersons) to make real-time sales decisions aligned with a profitable sales plan of the organization. The interactive sales planner uses detailed (i.e., disaggregated) target information of an optimized sales plan generated using business data of an organization. The method is highly efficient in organizations having many products, and many customers and complex production capabilities. It applies to account planning, customer negotiations, individual sales order negotiations, and ex post assessment of salesperson performance.

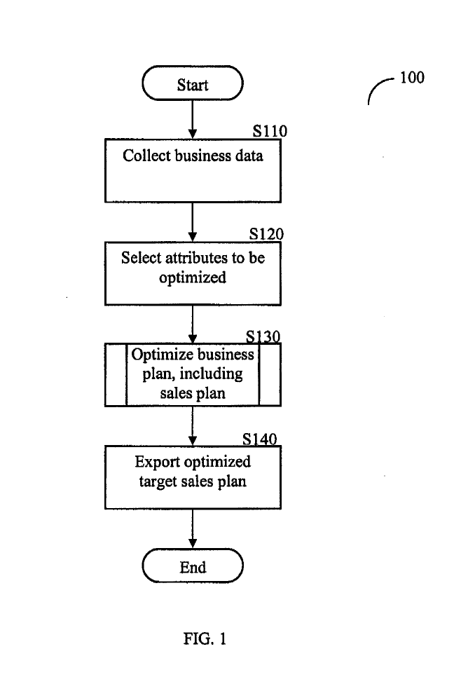

FIG. 1 shows an exemplary and non-limiting flowchart 100 describing the process of generating an optimized target sales plan. At S110, business data of the organization is collected from multiple data sources, such as those described above. Specifically, the data includes finance data (e.g., production costs), marketing data (e.g., product lists, new product lists, product attributes), sales data (e.g., customer lists, new customer lists, customer attributes, sales orders, sales order attributes), and production data (e.g., asset capabilities, asset rates, routings). A sales order includes price and quantity by combination of product, and customer, and deliver-to location. The business data may be based on historical or projected details, and it is preferably disaggregated but may be partially aggregated.

Optionally, at S120, the user specifies a list of attributes that may be important to optimize. The attributes are predefined and may be, but are not limited to, customer region, customer industry, customer market, sales order, deliver-to destination, product market segment, product group, sales person region, and so on. It should be noted that other attributes may be defined by the user and that the attributes may be different depending on the industry or business. The selection from among predefined attributes allows the optimization of the sales plan by a group of attributes, where the sales order quantities with identical attribute values across a selected group of attributes are held proportionally constant. For example, optimizing by the attribute, “customer,” provides the organization control over which customers to sell to, but not over which products, in their product catalog, from which customers may choose. Therefore, a product mix for a given customer is held in constant proportion with historical patterns of sales orders of the customers.

At S130, an optimization process is carried out. This optimization process includes the steps of: a) creating a mathematical model of a set of equations representing business factors, such as demand, production flow, capacity, and shipping; b) creating an objective function to maximize profit, such as cash contribution; and c) determining, by using an optimization engine, a set of values that satisfy the set of equations of the mathematical model and at the same time maximizing the cash contribution measured by the objective function. In accordance with an embodiment of the present invention the mathematical model is a linear program, i.e., a linear program is formed from the equations representing the business factors. An example for the execution of S130 may be found in U.S. patent application Ser. No. 11/860,473 entitled “A method for business plan optimization based on attributes”, assigned to the same assignee as the present application, and which is hereby incorporated by reference in its entirety, in particular the part of the description that relates to providing an optimized plan. The outcome and optionally an interim output of S130 is an optimized target sales plan.

At S140 optimum target information produced by the target sales plan is exported to the interactive sales planner. This information includes for each sales order at least one of: a target quantity, a target price, a target cash contribution per unit, and a target marginal cash contribution per unit. The target marginal cash contribution per unit implicitly accounts for the sales order's price, the cost, the asset-minutes required to produce one unit of the sales order's product, and the capacities of the assets (e.g., machines) used to produce the products. An asset's capacity refers to the available minutes for the asset, i.e., the number of minutes that the asset was available to manufacture products.

The target marginal cash contribution per unit for an organization with a single capacity-limited machine, a target product for which the target is being calculated, and a “marginal” product that is the least desirable product that is actually produced on the machine may be determined using the following equation:

Target Marginal Cash Contribution per Unit=Cash Contribution per Unit of a Target Product−(Cash Contribution per Unit of a Marginal Product*Units per Machine Minute of the Marginal Product)/Units per Machine Minute of a Target Product (1.)

As can be noticed from the above equation, if there is no marginal product (i.e., the machine has available minutes to produce all the products), the target marginal cash contribution per unit is the target product's cash contribution per unit. If the target product's cash contribution per unit is less than the marginal product's cash contribution per unit, adjusted by the units per machine minute, the target marginal cash contribution per unit is negative.

Other examples for computing the target marginal cash contribution per unit may be found in U.S. patent application Ser. No. 11/______ entitled “A method for generating an asset loading plan”, assigned to the already mentioned common assignee and which is hereby incorporated by reference in its entirety, especially the description related to generating an asset loading plan as thoroughly described and explained therein.

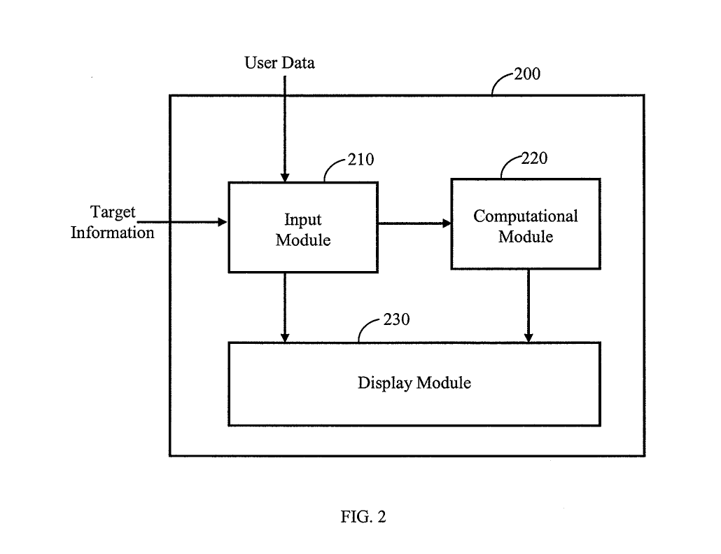

FIG. 2 shows an exemplary and non-limiting block diagram 200 of the interactive sales planner 200 constructed and operative in accordance with an embodiment of the present invention. The interactive sales planner 200 includes an input module 210, a computational module 220, and a display module 230. The input module 210 is adapted to receive input data entered by a user and target information from the optimization engine. The user may specify, for example, the quantities and prices for various sales orders. The input module 210 may communicate through a network (e.g., a wide area network) with a remote server or a storage device to retrieve the target information. The computational module 220 computes various sales measures relative to the target sales plan based on data entered by the user and the target information. These measures include, but are not limited to, a cash contribution, a cash contribution per unit, a marginal cash contribution, a marginal cash contribution per unit, and so on. The display module 230 presents as an output the details of the sales order, input data (entered by the user), computed sales measures, and target information. An exemplary diagram of the display and output generated by the display module 230 is provided below. The interactive sales planner 200 can be integrated and operated on a computer or computing means such as, but not limited to, a personal digital assistant (PDA), a mobile phone, a personal computer (PC), a workstation, a laptop computer, and the like. All of the foregoing well-known computing devices may be thought of generally as computer systems, each of which has a processor and a memory, the memory being under control of the processor and storing computer instructions which when executed by the processor enable the computer system to carry out the steps described in the preceding and following parts of the discussion. Other, later-developed types of computer systems may likewise be thought of in the same manner and are meant to be included within the ambit of the inventive concepts described herein.

In one configuration of the planner 200, the input module 210 and display module 230 may be part of an external system, such as a CRM system or an ERP system. In this configuration, the planner 200 allows users to send sales orders proposals to their managers for approval. In addition, managers can review a periodic (e.g., daily) report of the period's changes to revenue, cash contribution, marginal cash contribution, and so on, versus the target sales plan.

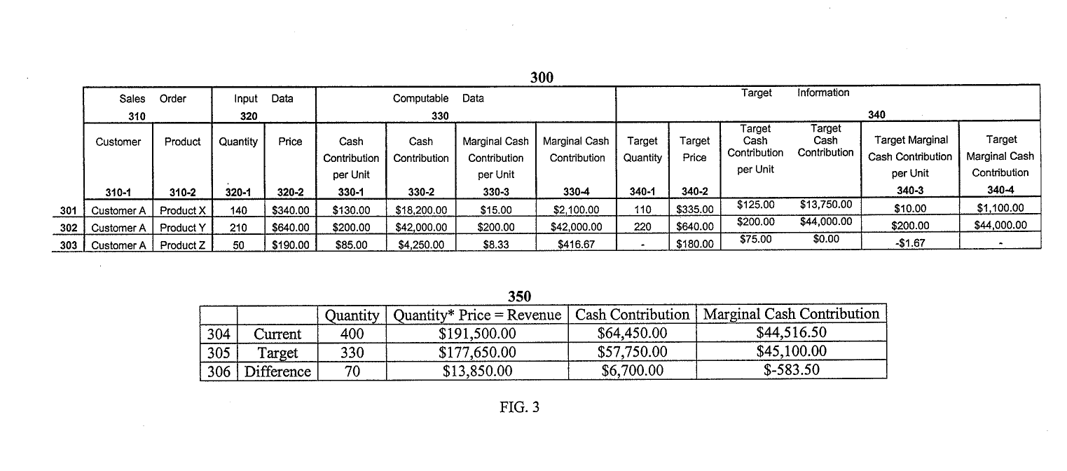

FIG. 3 shows an exemplary and non-limiting diagram of the interactive sales planner's display generated in accordance with an embodiment of the present invention. The planner's display is in the form of table 300. Each row of table 300 is a sales order, and the rows in total represent an account plan or the sales orders relevant to a specific customer. The table 300 includes the following fields: sales order information 310, input data 320, computable data 330, and target information 340. In the exemplary display shown in FIG. 3, the sales order information field 310 includes the columns of customer 310-1 and product 310-2. The input data field 320 includes the columns of quantity 320-1 and price 320-2, in which columns a user can enter data. The computable data field 330 includes the columns of cash contribution per unit 330-1, cash contribution 330-2, marginal cash contribution per unit 330-3, and marginal cash contribution 330-4. The target information includes the columns of target quantity 340-1, target price 340-2, target marginal cash contribution per unit 340-3, and a target marginal cash contribution 340-4 having values exported from the optimized sales plan. The values in the computable data field 330 are computed automatically based on the values in the input data field 320 and the target information field 340. In the example illustrated, the aim of a user is to find for a sales order the best combination of quantity and price while keeping the marginal cash contribution (column 330-4) positive and greater than the target marginal cash contribution (column 340-4).

The display also includes a summary table 350, that summaries that results shown in table 300. A current row 304 contains the sums of the corresponding “input data” and “computable data” columns 320 and 330. A target row 305 contains the sums of the corresponding columns 340, and a difference row 306 is the current row minus the target row. In this example, a user created a plan that increases volume, revenue and cash contribution but decreases marginal cash contribution. The decrease in marginal cash contribution provides a warning to the user that the deviations from target may look attractive by themselves, but they likely will displace more profitable “marginal” products, discussed above, from production assets due to capacity constraints. Thus, while most salespersons tend to make decisions in isolation from each other and from the manufacturing department, the described method provides an alert to the sales person that they may actually be destroying value relative to the target plan. Typically, in such a case an organization may require this user to seek approval before finalizing negotiations with the given customer.

It should be apparent to a person skilled in the art that the fields and columns shown in FIG. 3 are merely examples. Other information may be presented including specific customers and product attributes, sales order deliver-to location, variable cost, variable cost per unit, freight cost, freight cost per unit, standard profit, standard profit per unit, the differences between the various target and computed values of quantity, price, cash contribution, cash contribution per unit, marginal cash contribution, marginal cash contribution per unit, and so on. Furthermore, the table 300 may be viewed and edited at various levels of aggregation of customer and product attributes.

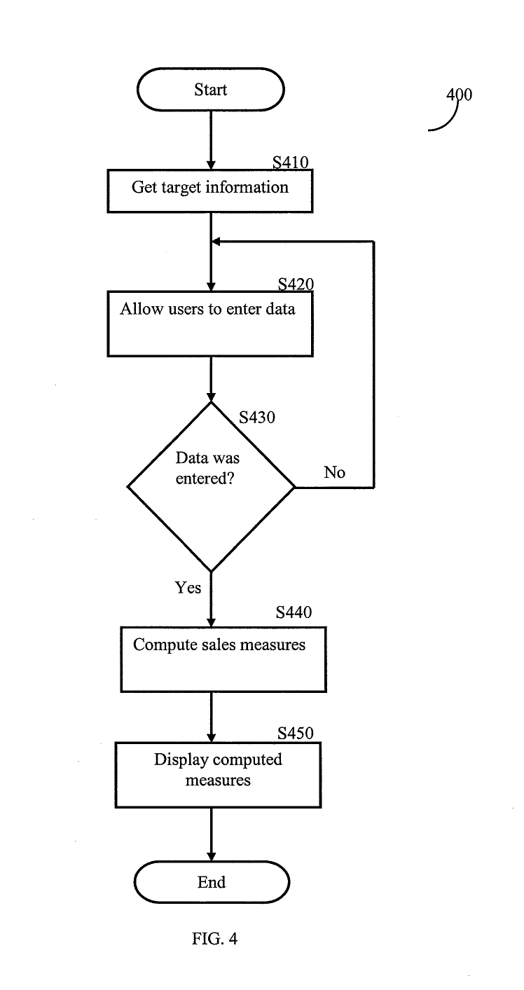

FIG. 4 shows a non-limiting flowchart 400 describing the method for interactively generating sales recommendations using the interactive sales planner implemented in accordance with an embodiment of the present invention. At S410, target information including at least one of: price, quantity, and marginal cash contribution per unit, is loaded from an optimization engine that produced an optimized sales plan. The target information may be related to a set of sales orders in which the user has an interest. For example, for a salesperson who manages the accounts of electronics chain stores, for example “CIRCUIT CITY®” and “BEST BUY™”, the appropriate sales planner according to an embodiment of the invention may include information on sales orders data related only to these customers. At S420, the user may modify the values in the input data field 320. For example, the user may change the quantity and/or price associated with a sales order. At S430, a check is performed to determine whether the user modified the values in the input data field 320, and if so execution continues with S440, otherwise execution returns to S420. At S440, sales measures, i.e., values in the computable field 330 are computed. The marginal cash contribution per unit (of a sales order) is computed using the following equation:

Marginal Cash Contribution per Unit=Target Marginal Cash Contribution per Unit+(Price−Target Price) (2.)

For example, the marginal cash contribution per unit of the sales order “301” provided in FIG. 3 equals to: $10+($340−$335)=$15. The marginal cash contribution per unit of the sales order “303” equals to: $−1.73.+($190−$180)=$8.33. The cash contribution of sales order “303” is positive although the target cash contribution per unit is negative. This is due to the fact that the price is higher than the target price.

It should be noted that if the cost and target cost of a sales order are provided as input, the marginal cash contribution per unit may be computed as follows:

Marginal Cash Contribution per Unit=Target Marginal Cash Contribution per Unit+(Price−Target Price)−(Cost−Target Cost) (3.)

The marginal cash contribution is computed as follows:

Marginal Cash Contribution=Marginal Cash Contribution per Unit*Quantity (4.)

Similar to Marginal Cash Contribution per Unit and Marginal Cash Contribution, Cash Contribution per Unit and Cash Contribution are computed as follows:

Cash Contribution per Unit=Target Cash Contribution per Unit+(Price−Target Price) (5.)

Cash Contribution=Cash Contribution per Unit*Quantity (6.)

If the cost and target cost of a sales order are provided as input, the cash contribution per unit may be computed as follows:

Cash Contribution per Unit=Target Cash Contribution per Unit+(Price−Target Price)−(Cost−Target Cost) (7.)

At S450, the sales measures computed at S440 as well as input data, target information, and sales order details are displayed to the user. It will be appreciated by a person familiar with this field that the tables and their content discussed can be presented in the form of charts, or any other tangible format in print, display, or otherwise.

The outputs generated by an interactive sales planner such as that described herein could help salespersons in the process of making tactical sales decisions regarding products and customers as well as easily managing customers' accounts and negotiating prices and quantities, while meeting or exceeding target cash contribution and target marginal cash contribution. The planner thus enables real-time decision making, for example, when the salesperson is at the customer premises. The computed marginal cash contributions are based on the target marginal cash contribution, which is an optimized measure generated according to the organization business goals. Furthermore, since the target marginal cash contribution takes into account production costs and assets capacities, the salesperson does not have to consider these factors explicitly while making a business decision.

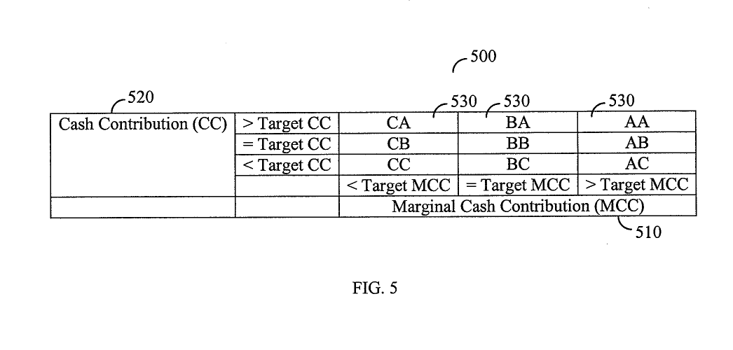

In accordance with an embodiment of the present invention the sales recommendations may be displayed in a matrix. This would allow a salesperson to easily determine if a specific item (e.g., sales order, account plan, set of sales orders, or set of account plans) is aligned with the target sales plan. An example for such a matrix 500 is provided in FIG. 5. The matrix 500 includes two dimensions: a marginal cash contribution 510 and a cash contribution 520. Other types of dimensions include, but are not limited to, revenue, volume, standard profit, marginal value per unit, cash contribution per unit, price, and standard profit per unit. The table may be broken into more or fewer than three value bands per dimension, dimensions may be aggregated via weighted averages, and more complex or simple prioritization schemes may be used.

The cells 530 include proposed metric values rated against the target metric values. In matrix 500 three grades are provided: A, B, and C. An A grade is determined when the item dimension's value exceeds the target value; a B grade is determined when the item dimension's value equals the target value; and a C grade is determined when the item dimension's value is lower than the target value. For example, if the marginal cash contribution is greater than target marginal cash contribution, the item receives a grade of A, if the item value is equal, the grade is B, and if the item value is less the grade is C. The cash contribution is ranked similarly. The grades are concatenated in order of priority for an overall grade. For example, if marginal cash contribution is greater than target marginal cash contribution and cash contribution is equal to target cash contribution, the grade is AB.

Using this approach, the overall result, row 306 of FIG. 3, with the metrics of marginal cash contribution and cash contribution would be CA. The rows 301, 302 and 303 would receive grades of “AA”, “CC” and “AA”, respectively, indicating to the user that he can modify row 302 to improve the overall score. Alternatively, the user can improve row 301 and/or 303 further to compensate for 302. Such grade indicators may be provided in any number of intuitively understandable formats. In a more general sense, such grade indicators may be thought of as alignment indicia (i.e., the indicators show the extent to which a particular course of action is aligned with an overall optimized plan).

It should be noted that the same evaluation approach may be used by managers to monitor and evaluate salespersons performance on a periodic basis. For example, a manager may view each salesperson's overall performance on a daily or weekly basis by having the computer system collect all of the salesperson's performance. If the salesperson has, for example, reduced marginal cash contribution, the manager may decide to provide additional guidance to the salesperson or exert additional control over the salesperson.

The methods and processes described herein can be implemented in software, hardware, firmware or any combination thereof. The product may be further included in a product that contains a plurality of instructions on a computer readable medium, and the instructions may be loaded into a memory by a device such as a processor of a computer system. The computer system thereby is enabled to support the performance of some or all of the instructions and as a result can execute the methods disclosed herein above.

There is claimed:

1. A computer implemented method of interactively and automatically generating sales recommendations aligned with an optimized target sales plan, comprising:
receiving target information of at least one sales order;
receiving input data of the sales order as entered by a user;
computing sales measures of the sales order based on the input data and the optimized target sales plan; and
generating an output including the target information, the input data, and the computed sales measures;
whereby the output is the generated sales recommendations and whereby the sales recommendations are automatically aligned with the optimized target sales plan.

2. The method of claim 1, wherein the target information comprises at least one of: price, quantity, marginal cash contribution per unit, and cost.

3. The method of claim 1, wherein the target information is automatically retrieved from the optimized target sales plan.

4. The method claim 1, wherein the input data comprises at least one of: quantity, price, cash contribution per unit, and cost.

5. The method of claim 1, wherein the sales measures comprise at least one of: cash contribution per unit, cash contribution, marginal cash contribution per unit, and marginal cash contribution.

6. The method of claim 1, further comprising: generating a matrix that includes metric values of the sales order rated against target metric values of the sales order.

7. The method of claim 6, wherein the metric values are of at least one of: cash contribution, marginal cash contribution, revenue, volume, standard profit, marginal cash contribution per unit, cash contribution per unit, price, and standard profit per unit.

8. The method of claim 1, wherein the output includes alignment indicia for indicating a degree of alignment of a particular course of action with the optimized target sales plan.

9. The method of claim 8, wherein the alignment indicia provide an indication for maximizing the profit of the sales order.

10. A computer program product for enabling a computer system to perform a computer implemented method of interactively and automatically generating sales recommendations aligned with an optimized target sales plan, the computer program product having computer instructions on a tangible computer readable medium, the computer instructions being adapted to enable the computer system, when executing the computer instructions, to perform operations, comprising:
receiving target information of at least one sales order;
receiving input data of the sales order as entered by a user;
computing sales measures of the sales order based on the input data and the optimized target sales plan; and
generating an output including the target information, the input data, and the computed sales measures;
whereby the output is the generated sales recommendations and whereby the sales recommendations are automatically aligned with the optimized target sales plan.

11. The computer program product of claim 10, wherein the target information comprises at least one of: price, quantity, marginal cash contribution per unit, cash contribution per unit, and cost.

12. The computer program product of claim 11, wherein the target information is automatically retrieved from the optimized target sales plan.

13. The computer program product claim 10, wherein the input data comprises at least one of: quantity, price, and cost.

14. The computer program product of claim 10, wherein the sales measures comprise at least one of; cash contribution per unit, cash contribution, marginal cash contribution per unit, and marginal cash contribution.

15. The computer program product of claim 10, further comprising: generating a matrix that includes metric values of the sales order rated against target metric values of the sales order.

16. The computer program of claim 15, wherein the metric values are of at least one of: cash contribution, marginal cash contribution, revenue, volume, standard profit, marginal cash contribution per unit, cash contribution per unit, price, and standard profit per unit.

17. The computer program product of claim 16, wherein the output includes alignment indicia for indicating a degree of alignment of a particular course of action with the optimized target sales plan.

18. The computer program product of claim 16, wherein the alignment indicia provide an indication for maximizing the profit of the sales order.

19. A computer-based interactive sales planner system, comprising:
an input module for receiving input data and target information of at least one sales order;
a computational module for computing sales measures using the target information and the input data; and
a display module for displaying the details of the sales order, the input data, the target information, and the computed sales measures.

20. The interactive sales planner of claim 19, wherein the input data is entered by a user.

21. The interactive sales planner of claim 19, wherein the target information is retrieved from an optimized target sales plan.

22. The interactive sales planner of claim 19, wherein the sales measures comprise at least one of: cash contribution per unit, cash contribution, marginal cash contribution per unit, and marginal cash contribution.

23. The interactive sales planner of claim 19, wherein the input module and display module are part of at least one of: a customer relationship management (CRM) system, and an enterprise resource planning (ERP).
